(19) United States
(12) Patent Application Publication
(10) Pub. No.: US 2023/0029772 A1
(43) Pub. Date: Feb. 2, 2023

(54) SECRET MAXIMUM VALUE CALCULATION APPARATUS, METHOD AND PROGRAM

(71) Applicant: NIPPON TELEGRAPH AND TELEPHONE CORPORATION, Tokyo (JP)

(72) Inventors: Koki HAMADA, Musashino-shi, Tokyo (JP); Ryo KIKUCHI, Musashino-shi, Tokyo (JP)

(73) Assignee: NIPPON TELEGRAPH AND TELEPHONE CORPORATION, Tokyo (JP)

(21) Appl. No.: 17/791,557

(22) PCT Filed: Jan. 17, 2020
(86) PCT No.: PCT/JP2020/001546

§ 371 Date: Jul. 8, 2022

(51) Int. Cl. H04L 9/32

(52) U.S. Cl. CPC H04L 9/3218

(57) ABSTRACT

A secure maximum value computation apparatus includes an initialization unit 1 that sets X′=X, a pair creation unit 2 that creates, from among the X′, one or more pairs such that no element is included in two or more pairs, a determination unit 3 that determines, through secure computation, a secret value that is a larger value among [[xᵢ]]and [[xᵢ]] included in each of the one or more pairs for each of the one or more pairs that are created, a set updating unit 4 that sets, as a new X′, when there is a secret value that is not included in the one or more pairs in the X′, a set including the secret value that is not included in the one or more pairs in the X′ and the secret value determined by the determination unit, a control unit 5 that performs a control to repeat the above-described processing operations until |X′|=1 holds, and a flag determination unit 6 that determines a flag [[z(xᵢ)]] (i=1, . . . n) such that [[z(x_{g})]]=[[1]] holds when [[x_{g}]] (g∈[1, n]) is a maximum value and [[z(xᵢ)]]=[[0]] holds when i≠g holds.

### TECHNICAL FIELD

The present disclosure relates to an encryption applied technique, and particularly to a method of computing a maximum value and a flag of a maximum value without revealing input or output.

### BACKGROUND ART

There is a method called secure computation as a method of obtaining a specific operation result without restoring encrypted numerical values (see, for example, NPL 1). In the method disclosed in NPL 1, an encryption in which fragments of numerical values are distributed among three secure computation apparatuses is performed and a coordinate computation is performed by the three secure computation apparatuses, and thus, without restoring the numerical value, it is possible to retain a state where results of addition/subtraction, constant addition, multiplication, constant multiplication, logical operations (negation, logical product, logical sum, exclusive logical sum), and data format conversion (integer, binary) are distributed among three secure computation apparatuses, i.e., an encrypted state. For computation of the maximum value of n values encrypted by the secure computation and the flag of the maximum value, there is a method in which the current maximum value and the number of the element of the maximum value are held as a cipher text, sequential comparison with n cipher texts is performed, the maximum value and the number of the element of the maximum value are updated, and finally the flag is computed from the number (for example see NPL 2).

### CITATION LIST

### Non Patent Literature

NPL 1 CHIDA KOJI, HAMADA KOKI, IKARASHI DAI, TAKAHASHI KATSUMI, A Three-Party Secure Function Evaluation with Lightweight Verifiability Revisited, In CSS, 2010. NPL 2 Sameer Wagh, Divya Gupta, and Nishanth Chandran. Securenn: 3-party secure computation for neural network training. Proceedings on Privacy Enhancing Technologies, Vol. 1, p. 24, 2019.

### SUMMARY OF THE INVENTION

### Technical Problem

In the known method; however, the number of comparison stages is as large as Θ(n) while the total number of comparisons for computing the maximum value is as large as Θ(n).

An object of the present disclosure is to provide a secure maximum value computation apparatus, a method, and a program whose processing time is reduced.

### Means for Solving the Problem

A secure maximum value computation apparatus according to an aspect of the present disclosure includes an initialization unit that sets X′=X, assuming X={[[x₁]], [[x₂]], . . . , [[xₙ]]}, a pair creation unit that creates, from among the X′, one or more pairs such that no element in the X′ is included in two or more pairs, a determination unit that determines, through secure computation, a secret value that is a larger value among [[xᵢ]] and [[xⱼ]] included in each of the one or more pairs, with respect to an order R for each of the one or more pairs that are created, a set updating unit that sets, as a new X′, when there is a secret value that is not included in the one or more pairs in the X′, a set including the secret value that is not included in the one or more pairs in the X′ and the secret value determined by the determination unit, a control unit that performs a control to repeat, with the new X′ as the X′, processing operations of the pair creation unit, the determination unit, and the set updating unit until |X′|=1 holds, and a flag determination unit that determines, with a secret value that is an only element of the X′ that meets |X′|=1 as a maximum value, a flag [[z(xᵢ)]] (i=1, . . . n) such that [[z(x_{g})]]=[[1]] holds when [[x_{g}]] (g∈[1, n]) is a maximum value and [[z(xᵢ)]]=[[0]] holds when i≠g holds.

### Effects of the Invention

The processing time can be reduced.

### BRIEF DESCRIPTION OF DRAWINGS

FIG. 1 is a diagram illustrating an example of a functional configuration of a secure maximum value computation apparatus.

FIG. 2 is a diagram illustrating an example of a processing procedure of a secure maximum value computation method.

FIG. 3 is a diagram illustrating an example of a functional configuration of a computer.

### DESCRIPTION OF EMBODIMENTS

An embodiment of the present disclosure is elaborated below. Note that in the drawings, the components with the same function are denoted with the same reference numeral, and overlapping description thereof is omitted.

Notation

A value of a certain value a hid by encryption, secret sharing and the like is referred to as a secret value of a and represented as [[a]]. In the case where the hiding is performed by secret sharing, a set of fragments of the secret sharing held by each secure computation apparatus according to the [[a]] is referenced.

Decryption

Processing of computing a value c that meets c=a with an input of a secret value [[a]] of a is described as follows.

c←Open([[a]])

Arithmetic Operation

In operations of addition, subtraction, and multiplication, secret values [[c9₁]], [[c₂]]and [[c₃]] of computation results c₁, c₂ and c₃ of a+b, a−b and ab, respectively, are computed with secret values [[a]] and [[b]] of two values a and b as inputs. Executions of these operations are described as follows.

[[c₁]]←Add([[a]], [[b]])

[[c₂]]←Sub([[a]], [[b]])

[[c₃]]←Mul([[a]], [[b]])

In the case where there is no possibility of misunderstanding, Add([[a]], [[b]]), Sub([[a]], [[b]]) and Mul([[a]], [[b]]) are abbreviated as [[a]]+[[b]], [[a]]−[[b]] and [[a]]×[[b]], respectively.

Comparison

In comparison operation, the secret values [[c₁]], [[c₂]] and [[c₃]] of Boolean values c∈{0, 1} of a=b, a≤b, a<b, respectively, are computed with the secret values [[a]] and [[b]] of the two values a and b as inputs. The Boolean value is 1 when true and 0 when false. Executions of these operations are described as follows.

[[c₀]]←EQ([[a]], [[b]])

[[c₁]]←LE([[a]], [[b]])

[[c₂]]←LT([[a]], [[b]])

Selection

In selection operation, with a secret value [[c]] of a Boolean value c∈{0, 1} and the secret values [[a]] and [[b]] of two values a and b as inputs, and

$$d = \{ \begin{matrix}a & if c = 1 , \\ b & otherwise\end{matrix} , \qquad [ Math 1 ]$$

a secret value [[d]] that meets Math 1 is computed. Execution of the above operation is described as follows.

[[d]]←IfElse([[c]], [[a]], [[b]]) The above operation can be achieved by the following.

[[d]]←[[c]]×([[a]]−[[b]])+[[b]]

Secure Maximum Value Computation Apparatus and Method

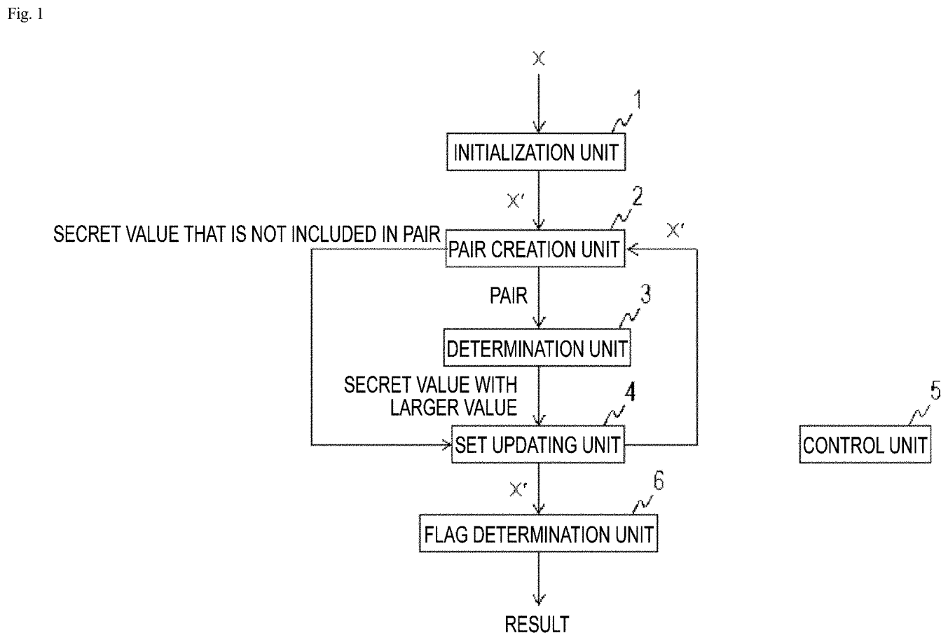

As illustrated in FIG. 1, a secure maximum value computation apparatus includes an initialization unit 1, a pair creation unit 2, a determination unit 3, a set updating unit 4, a control unit 5 and a flag determination unit 6, for example.

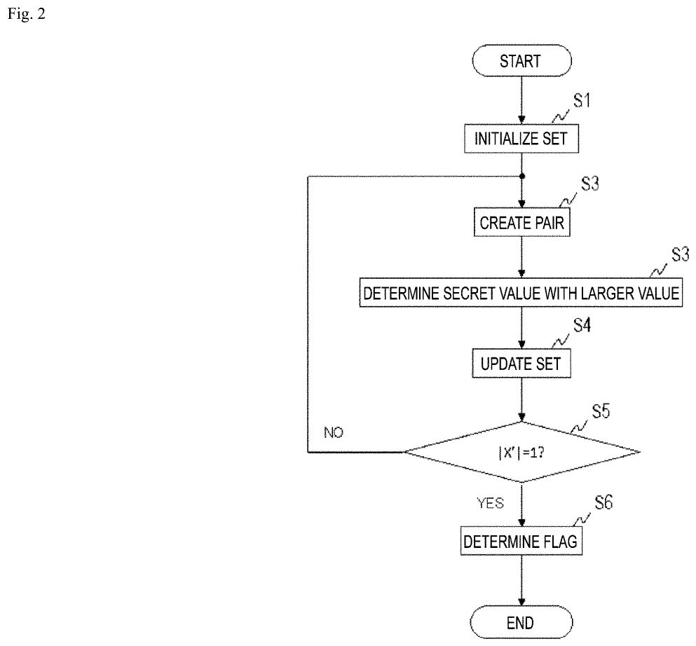

The secure maximum value computation method is achieved when the components of the secure maximum value computation apparatus perform the processing operations of steps S1 to S6 described below and illustrated in FIG. 2, for example.

Each component of the secure maximum value computation apparatus is described below.

Initialization Unit 1

X={[[x₁]], [[x₂]], . . . , [[xₙ]]} is input to the initialization unit 1. The n is a predetermined positive integer of 2 or greater. For example, n≥4 holds.

The initialization unit 1 initializes a set X′ by setting X′=X (step S1).

The initialized X′ is output to the pair creation unit 2.

Pair Creation Unit 2

The X′ initialized by the initialization unit 1 is input to the pair creation unit 2. Note that in the second and subsequent processing operations of the pair creation unit 2, the X′ updated by the set updating unit 4 is input.

The pair creation unit 2 creates one or more pairs such that no element in the X′ is included in two or more pairs from among the input X′ (step S2).

The created one or more pairs are output to the determination unit 3. In addition, when there is a secret value that is not included in the one or more pairs in the X′, the secret value that is not included in the one or more pairs in the X′ is output to the set updating unit 4.

For example, the pair creation unit 2 creates two or more pairs at least once. In the case where n≥4 holds, comparison can be performed through computation of n−2 stages or less.

Determination Unit 3

The one or more pairs created by the pair creation unit 2 are input to the determination unit 3.

For each of the one or more created pairs, the determination unit 3 determines, through secure computation, a secret value of a larger value among the [[xᵢ]] and the [[xⱼ]] included in each of the one or more pairs, with respect to an order R (step S3).

The determined secret value of the larger value is output to the set updating unit 4.

Set Updating Unit 4

The secret value of the larger value determined by the determination unit 3 is input to the set updating unit 4. In addition, when there is a secret value that is not included in the one or more pairs in the X′, the secret value that is not included in the one or more pairs in the X′ is input to the set updating unit 4.

When there is a secret value that is not included in the one or more pairs in the X′, the set updating unit 4 sets, as a new X′, a set including the secret value that is not included in one or more pairs in the X′ and the secret value determined by the determination unit 3 (step S4).

Control Unit 5 0

The control unit 5 performs a control to repeat, with the new X′ generated by the set updating unit 4 as X′, the processing operations of the pair creation unit 2, the determination unit 3 and the set updating unit 4 until=1 holds (step S5).

Here, |X′| is the number of elements included in the set X′.

The X′ that meets |X′|=1 is output to the flag determination unit 6.

Flag Determination Unit 6

The X′ that meets |X′|=1 is input to the flag determination unit 6.

With a secret value that is an only element of the X′ that meets |X′|=1 as a maximum value, the flag determination unit 6 determines a flag [[z(xᵢ)]] (i=1, . . . , n) such that [[z(x_{g})]]=[[1]] holds when [[x_{g}]] (g∈[1, n]) is a maximum value and [[z(x_{i)]]=[[}0]] holds when i≠g holds (step S6).

For example, the flag determination unit 6 determines the flag [[z(xᵢ)]] by performing the following processing operations (a) and (b), on [xᵢ] that is included in the X′ even once. The computation of the flag [[z(xᵢ)]] is performed in the reverse order of the computations of the pair creation unit 2, the determination unit 3, the set updating unit 4 and the control unit 5.

(a) The flag determination unit 6 sets [[z(x_{g})]]=[[1]] when [[xᵢ]] is [[x_{g}]].

(b) When the [[xₖ]] is computed by the comparison between the [[xᵢ]] and the [[xᵢ]] and the [[z(xₖ)]] has already been computed, the flag determination unit 6 uses the comparison result of the [[xᵢ]] and the [[xⱼ]], and the [[z(xₖ)]] to perform computation such that [[z(x₊)]]=[[xₖ]] holds for [[x₊]], which is the larger one of the [[xᵢ]] and the [[xⱼ]], and that [[z(x₋)]]=[[0]] holds for [[x₋]], which is not the larger one of the [[xᵢ]] and the [[xⱼ]].

In a known method, the maximum value is sequentially updated from a set of secret values while maintaining the maximum value, and as such the number of comparison stages is Θ(n). On the other hand, a small number of comparison stages can be achieved by recursively calculating the maximum value while exponentially reducing the problem as in the above embodiment.

To be more specific, in the case where a secret value of a maximum value and a secret value of a flag indicating whether it is the maximum value are computed from a set of secret values with a size n, the number of comparison stages is Θ(n) in the known method. Conversely, in the secure maximum value computation apparatus and method according to the present disclosure, the number of comparison stages can be reduced while maintaining the total number of comparisons at Θ(n) by appropriately selecting the comparison order.

### Example of Algorithm

An example of an algorithm achieved by the above-mentioned secure maximum value computation apparatus and method is described below. In this algorithm, in creation of pairs, ^{└}|X′|/2^{┘} pairs are created. Note that ^{└}X′|/2^{┘} is a maximum integer of |X′|/2 or smaller. With this algorithm, the number of comparison stages can be asymptotically set to O(log n) for n.

Input: X={[[x₁]], . . . , [[xₙ]]}

Output: [[y]], [[z(x₁)]], . . . , [[z(xₙ)]]

Notation: [[y]], [[z(x₁)]], . . . , [[z(xₙ)]]←f([[x₁]], . . . , [[xₙ]])

(1) If n=1 holds, return [[y]]=[[x₁]] and [[z(x₁)]]=[[z(x₁]]=[[1]], and terminate.

(2) When n is a multiple of 2, execute the following (2-a) to (2-f).

(2-a) h←n/2

(2-b) [[fᵢ]]←LE([[xᵢ]], [[xᵢ₊ₕ]]) (i∈[1, h])

(2-c) [[mᵢ]]←IfElse([[fᵢ]], [[xᵢ₊ₕ]], [[xᵢ]]) (i∈[1, h])

(2-d) [[y]], [[z(m₁)]], . . . , [[z(mₕ)]]←f([[m₁]], . . . , [[mₕ]])

(2-e) [[z(xᵢ)]]←[[z(mᵢ)]]×(1−[[fᵢ]]) (i∈[1, h])

(2-f) [[z(xᵢ₊ₕ)]]←[[z(mᵢ)]]×(i∈[1, h])

(3) When n is not a multiple of 2, execute the following.

(3-a) h←(n−1)/2

(3-b) [[fᵢ]]←LE([[xᵢ]], [[xᵢ₊ₕ]]) (i∈[1, h])

(3-c) [[mᵢ]]←IfElse([[fᵢ]], [[xᵢ₊ₕ]], [[xᵢ]]) (i∈[1, h])

(3-d) [[mₕ₊₁]]←[[xₙ]]

(3-e) [[y]], [[z(m₁)]], . . . , [[z(mₕ)]], [[z(mₕ₊₁]]←f([[m₁]], . . . , [[mₕ₊₁]])

(3-f) [[z(xᵢ)]]←[[z(mᵢ)]]×(1−[[fᵢ]]) (i∈[1, h])

(3-g) [[z(xᵢ₊ₕ)]]←[[z(mᵢ)]]×[[fᵢ]] (i∈[1, h])

(3-h) [[z(xₙ)]]←[[z(mₕ₊₁)]]

In (2-b), (2-c), (3-b) and (3-c), a pair of [[xᵢ]] and [[xᵢ₊ₕ]] is used. Although not explicitly stated in the above-mentioned algorithm, this creation of the pair corresponds to the process of the pair creation unit 2.

(2-b), (2-c), (3-b) and (3-c) correspond to the processing of the determination unit 3.

In (2-d), a recursive algorithm is performed on a new set [[m₁]], . . . , [[mₕ]]. This new set [[m₁]], . . . , [[mₕ]] corresponds to X′. The determination of this new set X′=[[m₁]], [[mₕ]] corresponds to the processing of the set updating unit 4.

Likewise, in (3-d) and (3-e), a recursive algorithm is performed on a new set [[m₁]], [[mₕ₊₁]]. This new set [[m₁]], . . . , [[mₕ₊₁]] corresponds to X′. The determination of this new set X′=[[m₁]], . . . , [[mₕ₊₁]] corresponds to the process of the set updating unit 4.

In addition, the part where the algorithm is recursively performed in (2-d) and (3-e) corresponds to the processing of the control unit 5.

(3-f), (3-g) and (3-h) correspond to the processing of the flag determination unit 6.

### Modified Examples

Although the embodiments of the present disclosure have been described above, a specific configuration is not limited to the embodiments, the present disclosure, of course, also includes configurations appropriately changed in design without departing from the gist of the present disclosure.

The various kinds of processing described in the embodiments are not only implemented in the described order in a time-series manner but may also be implemented in parallel or separately as necessary or in accordance with a processing capability of the apparatus which performs the processing.

For example, the exchange of data between the components of the secure maximum value computation apparatus may be performed directly or via a storage unit not illustrated.

Program and Recording Medium

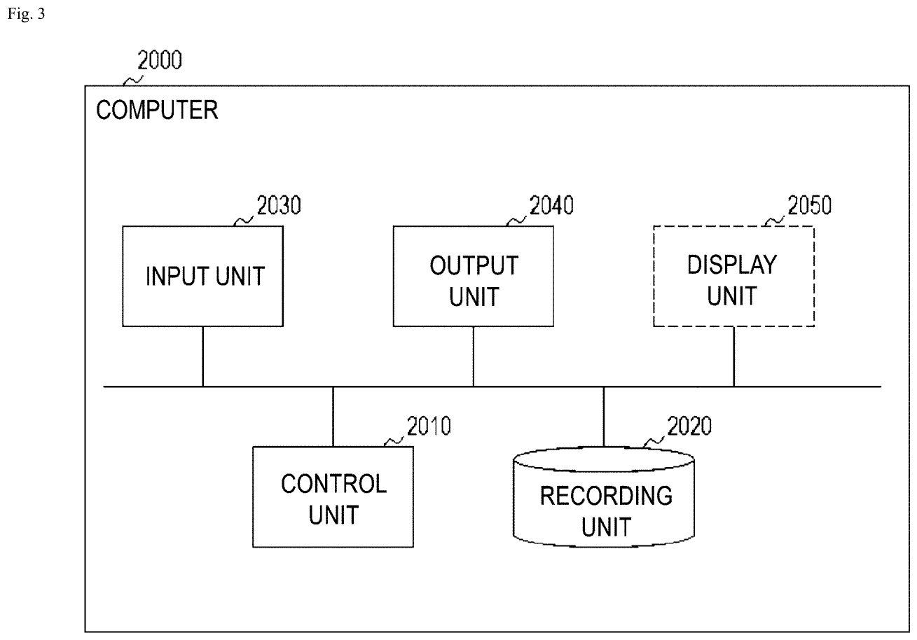

When various processing functions in the devices described above are implemented by a computer, processing details of the functions that each of the devices should have are described by a program. In addition, when the program is executed by the computer, the various processing functions of each device described above are implemented on the computer. For example, a variety of processing described above can be performed by causing a recording unit 2020 of the computer illustrated in FIG. 3 to read a program to be executed and causing a control unit 2010, an input unit 2030, an output unit 2040, and the like to execute the program.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in its own storage device. When executing the processing, the computer reads the program stored in its own storage device and executes the processing in accordance with the read program. Further, as another execution form of this program, the computer may directly read the program from the portable recording medium and execute processing in accordance with the program, or, further, may sequentially execute the processing in accordance with the received program each time the program is transferred from the server computer to the computer. In addition, it can also be configured to execute the processing described above through a so-called application service provider (ASP) type service in which processing functions are implemented just by issuing an instruction to execute the program and obtaining results without transmitting the program from the server computer to the computer. Further, the program in this form is assumed to include information which is provided for processing of a computer and is equivalent to a program (data or the like that has characteristics of defining the processing of the computer rather than being a direct instruction to the computer).

In addition, although the device is configured by executing a predetermined program on a computer in this form, at least a part of the processing details may be implemented by hardware.

### REFERENCE SIGNS LIST

1 Initialization unit

2 Pair creation unit

3 Determination unit

4 Set updating unit

5 Control unit

6 Flag determination unit

1.-3. (canceled)

4. A secure maximum value computation apparatus comprising:
initialization circuitry configured to set X′=X, assuming X={((x₁)), ((x₂)), . . . , ((xₙ))};
pair creation circuitry configured to create, from among the X′, one or more pairs in such a manner that no element in the X′ is included in two or more pairs;
determination circuitry configured to determine, through secure computation, a secret value that is a larger value among ((xᵢ)) and ((xⱼ)) included in each of the one or more pairs, with respect to an order R for each of the one or more pairs that are created;
set updating circuitry configured to set, as a new X′, when there is a secret value that is not included in the one or more pairs in the X′, a set including the secret value that is not included in the one or more pairs in the X′ and the secret value determined by the determination circuitry;
control circuitry configured to perform a control to repeat, with the new X′ as the X′, processing operations of the pair creation circuitry, the determination circuitry, and the set updating circuitry until |X′|=1 holds; and
flag determination circuitry configured to determine, with a secret value that is an only element of the X′ that meets X′=I as a maximum value, a flag ((z(xᵢ))) (i=1, . . . , n) in such a manner that ((z(x_{g})))=((1)) holds when ((x_{g})) (g∈[1, n]) is a maximum value and ((z(xᵢ)))=((0)) holds when i≠g holds.

5. A secure maximum value computation method comprising:
setting X′=X, assuming X={((x₁)), ((x₂)), . . . , ((xₙ))};
creating, from among the X′, one or more pairs in such a manner that no element in the X′ is included in two or more pairs;
determining, through secure computation, a secret value that is a larger value among ((xᵢ)) and ((xⱼ)) included in each of the one or more pairs, with respect to an order R for each of the one or more pairs that are created;
setting, as a new X′, when there is a secret value that is not included in the one or more pairs in the X′, a set including the secret value that is not included in the one or more pairs in the X′ and the secret value which has been determined;
performing a control to repeat with the new X′ as the X′, processing operations of the creating of the one or more pairs, the determining, and the setting as the new X′ until |X′|=1 holds; and
determining with a secret value that is an only element of the X′ that meets |X′|=1 as a maximum value, a flag ((z(xᵢ)))(i=1, . . . , n) in such a manner that ((z(x_{g})))=((1)) holds when ((x_{g})) (g∈[1, n]) is a maximum value and ((z(xᵢ)))=((0)) holds when i≠g holds.

6. A non-transitory computer readable medium that stores a program configured to cause a computer to perform as each step of the secure maximum value computation method according to claim 5.
